(19) United States
(12) Patent Application Publication
(10) Pub. No.: US 2016/0059444 A1
(43) Pub. Date: Mar. 3, 2016

(54) Production of highly conductive graphitic films from polymer films

(71) Applicants: Yanbo Wang, Huber Heights, OH (US); Bor Z. Jang, Centerville, OH (US); David Burton, Waynesville, OH (US); Lucy Fu, Centerville, OH (US); Aruna Zhamu, Springboro, OH (US)

(72) Inventors: Yanbo Wang, Huber Heights, OH (US); Bor Z. Jang, Centerville, OH (US); David Burton, Waynesville, OH (US); Lucy Fu, Centerville, OH (US); Aruna Zhamu, Springboro, OH (US)

(21) Appl. No.: 14/121,387

(22) Filed: Aug. 29, 2014

(51) Int. Cl. B29C 35/02; C01B 31/04

(52) U.S. Cl. CPC B29C 35/0277; C01B 31/04; C01P 2006/32; C01P 2006/40

(57) ABSTRACT

A one-step (direct graphitization) process for producing a graphitic film, comprising directly feeding a precursor polymer film, without going through a carbonization step, to a graphitization zone preset at a graphitization temperature no less than 2,200° C. for a period of residence time sufficient for converting the precursor polymer film to a porous graphitic film having a density from 0.1 g/cm³ to 1.5 g/cm³ and retreating the porous graphitic film from the graphitization zone. Preferably, the precursor polymer film is selected from the group consisting of polyimide, polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polyacrylonitrile, and combinations thereof. Preferably, the precursor polymer film contains an amount of graphene sheets or expanded graphite flakes, preferably from 1% to 90% by weight, sufficient for promoting or accelerating graphitization.

### FIELD OF THE INVENTION

The present invention relates generally to the field of graphitic materials for electromagnetic interference (EMI) shielding and heat dissipation applications and, more particularly, to an electrically and thermally conductive graphitic film obtained from a polymer or carbon precursor film.

### BACKGROUND OF THE INVENTION

Advanced EMI shielding and thermal management materials are becoming more and more critical for today's microelectronic, photonic, and photovoltaic systems. These systems require shielding against EMI from external sources. These systems can be sources of electromagnetic interference to other sensitive electronic devices and, hence, must be shielded. Materials for EMI shielding applications must be electrically conducting.

Further, as new and more powerful chip designs and light-emitting diode (LED) systems are introduced, they consume more power and generate more heat. This has made thermal management a crucial issue in today's high performance systems. Systems ranging from active electronically scanned radar arrays, web servers, large battery packs for personal consumer electronics, wide-screen displays, and solid-state lighting devices all require high thermal conductivity materials that can dissipate heat more efficiently. Furthermore, many microelectronic devices (e.g. smart phones, flat-screen TVs, tablets, and laptop computers) are designed and fabricated to become increasingly smaller, thinner, lighter, and tighter. This further increases the difficulty of thermal dissipation. Actually, thermal management challenges are now widely recognized as the key barriers to industry's ability to provide continued improvements in device and system performance.

Heat sinks are components that facilitate heat dissipation from the surface of a heat source, such as a CPU or battery in a computing device, to a cooler environment, such as ambient air. Typically, heat transfer between a solid surface and the air is the least efficient within the system, and the solid-air interface thus represents the greatest barrier for heat dissipation. A heat sink is designed to enhance the heat transfer efficiency between a heat source and the air mainly through increased heat sink surface area that is in direct contact with the air. This design enables a faster heat dissipation rate and thus lowers the device operating temperature.

Materials for thermal management applications (e.g. as a heat sink or heat spreader) must be thermally conducting. Typically, heat sinks are made from a metal, especially copper or aluminum, due to the ability of metal to readily transfer heat across its entire structure. Cu and Al heat sinks are formed with fins or other structures to increase the surface area of the heat sink, often with air being forced across or through the fins to facilitate dissipation of heat to the air. However, there are several major drawbacks or limitations associated with the use of metallic heat sinks. One drawback relates to the relatively low thermal conductivity of a metal (<400 W/mK for Cu and 80-200 W/mK for Al alloy). In addition, the use of copper or aluminum heat sinks can present a problem because of the weight of the metal, particularly when the heating area is significantly smaller than that of the heat sink. For instance, pure copper weighs 8.96 grams per cubic centimeter (g/cm³) and pure aluminum weighs 2.70 g/cm³. In many applications, several heat sinks need to be arrayed on a circuit board to dissipate heat from a variety of components on the board. If metallic heat sinks are employed, the sheer weight of the metal on the board can increase the chances of the board cracking or of other undesirable effects, and increases the weight of the component itself. Many metals do not exhibit a high surface thermal emissivity and thus do not effectively dissipate heat through the radiation mechanism.

Thus, there is a strong need for a non-metallic heat sink system effective for dissipating heat produced by a heat source such as a CPU and battery in a device. The heat sink system should exhibit a higher thermal conductivity and/or a higher thermal conductivity-to-weight ratio as compared to metallic heat sinks. These heat sinks must also be mass-producible, preferably using a cost-effective process. This processing ease requirement is important since metallic heat sinks can be readily produced in large quantities using scalable techniques such as extrusion, stamping, and die casting.

One group of materials potentially suitable for both EMI shielding and heat dissipation applications is the graphitic carbon or graphite. Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall. Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

Bulk natural graphite powder is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). Although all the graphene planes in one grain are parallel to one another, typically the graphene planes in one grain and the graphene planes in an adjacent grain are different in orientation. In other words, the orientations of the various grains in a graphite particle typically differ from one grain to another. This presents a problem as explained below:

A graphite single crystal (crystallite) per se or a crystalline grain in a graphite particle is anisotropic with a property measured along a direction in the basal plane (crystallographic a- or b-axis direction) being dramatically different than if measured along the crystallographic c-axis direction (thickness direction). For instance, the thermal conductivity of a graphite single crystal can be up to approximately 1,920 W/mK (theoretical) or 1,800 W/mK (experimental) in the basal plane (crystallographic a- and b-axis directions), but that along the crystallographic c-axis direction is less than 10 W/mK (typically less than 5 W/mK). Furthermore, there are large amounts of highly deficient boundaries between grains that impede the movement of electrons and phonons (quantized lattice vibrations), the two heat conduction mechanisms according to quantum mechanics. Consequently, a natural graphite particle composed of multiple grains of different orientations with highly defected grain boundaries exhibits an average property between these two extremes. This average conductivity, typically less than 200 W/mK, is insufficient for microelectronic device heat dissipation applications.

One approach to overcoming this problem is to make use of flexible graphite foil. The flexible graphite foil is obtained by the following typical steps: (a) intercalating particles of natural graphite with an intercalant (e.g. mixture of sulfuric acid and nitric acid) to form a graphite intercalation compound (GIC); (b) exposing the GIC to a thermal shock treatment (typically 650°-1,100° C.) to produce exfoliated graphite (also referred to as graphite worms); and then (c) compressing or roll-pressing exfoliated graphite worms into paper-like sheets or foil. Details are given in a later section. For electronic device thermal management applications (e.g. as a heat sink material in a smart phone), flexible graphite (FG) foils have the following major deficiencies:
(1) As indicated earlier, FG foils exhibit a relatively low thermal conductivity, typically <500 W/mK and more typically <300 W/mK. By impregnating the exfoliated graphite with a resin, the resulting composite exhibits an even lower thermal conductivity (typically <<200 W/mK, more typically <100 W/mK).
(2) Flexible graphite foils, without a resin impregnated therein or coated thereon, are of low strength, low rigidity, and poor structural integrity. The high tendency for flexible graphite foils to get torn apart makes them difficult to handle in the process of making a heat sink. As a matter of fact, the flexible graphite sheets (typically 50-200 μm thick) are so “flexible” that they are not sufficiently rigid to make a fin component material for a finned heat sink.
(3) Another very subtle, largely ignored or overlooked, but critically important feature of FG foils is their high tendency to get flaky with graphite flakes easily coming off from FG sheet surfaces and emitting out to other parts of a microelectronic device. These highly electrically conducting flakes (typically 1-200 μm in lateral dimensions and >100 nm in thickness) can cause internal shorting and failure of electronic devices.

A new class of nano carbon material is graphene, a 2-D material having a hexagonal arrangement of carbon atoms. These honeycomb-like carbon atoms can form a free standing sheet that is one-atom thick, which is now commonly referred to as a single-layer graphene sheet. Several layers of graphene planes can be bonded together to form a multi-layer graphene sheet or platelets, which contain less than 300 graphene planes or layers (or thinner than 100 nm), preferably less than 20 layers, and further preferably less than 10 layers (few-layer graphene). In both single-layer graphene and multi-layer graphene sheets, the graphene planes or edges can contain some non-carbon elements, such as hydrogen, oxygen, nitrogen, and fluorine, to name just a few. All these single-layer or multi-layer graphene sheets (0.24 nm to 100 nm thick) are herein collectively referred to as nano graphene platelets (NGPs). This is further discussed in a later section.

Multiple sheets of a graphene material (e.g. discrete nano sheets/platelets of pristine graphene, graphene oxide, reduced graphene oxide, graphene fluoride, nitrogenated graphene, hydrogenated graphene, boron-doped graphene, etc.) can be packed into a film, membrane, or paper sheet (34 in FIG. 1(A)). These aggregates typically do not exhibit a high thermal conductivity unless these sheets/platelets are closely packed and the film/membrane/paper is ultra-thin (e.g. <1 which is mechanically weak). This is reported in our earlier U.S. patent application Ser. No. 11/784,606 (Apr. 9, 2007). In general, a paper-like structure or mat made from platelets of graphene, graphene oxide (GO), or reduced graphene oxide (RGO) (e.g. those paper sheets prepared by vacuum-assisted filtration process) exhibit many defects, wrinkled or folded graphene sheets, interruptions or gaps between platelets, and non-parallel platelets (e.g. SEM image in FIG. 3(B)), leading to relatively poor thermal conductivity, low electric conductivity, and low structural strength. These papers or aggregates of discrete graphene, GO or RGO platelets alone (without a resin binder) also have a tendency to get flaky, emitting conductive particles into air.

Our earlier application (U.S. application Ser. No. 11/784,606) also disclosed a mat, film, or paper of NGPs infiltrated with a metal, glass, ceramic, resin, and CVD carbon matrix material (graphene sheets/platelets being the filler or reinforcement phase, not the matrix phase in this earlier application). Haddon, et al. (US Pub. No. 2010/0140792, Jun. 10, 2010) also reported NGP thin film and NGP-reinforced polymer matrix composites for thermal management applications. The NGP-reinforced polymer matrix composites, as an intended thermal interface material, have very low thermal conductivity, typically <<2 W/mK. The NGP films of Haddon, et al are essentially non-woven aggregates of discrete graphene platelets, identical to those of our earlier invention (U.S. application Ser. No. 11/784,606). Again, these aggregates have a great tendency to have graphite particles flaking and separated from the film surface, creating internal shorting problem for the electronic device containing these aggregates. They also exhibit low thermal conductivity unless made into thin films (10 nm-300 nm, as reported by Haddon, et al) which are very difficult to handle in a real device manufacturing environment. Balandin, et al (US Pub. No. 2010/0085713, Apr. 8, 2010) disclosed a graphene layer produced by CVD deposition or diamond conversion for heat spreader application. More recently, Kim, et al (N. P. Kim and J. P. Huang, “Graphene Nanoplatelet Metal Matrix,” US Pub. No. 2011/0108978, May 10, 2011) reported metal matrix infiltrated NGPs. However, the metal matrix is too heavy and the resulting metal matrix composite does not exhibit a high thermal conductivity.

The pyrolytic graphite, normally in a thick bulk form (not thin film), is produced by high temperature decomposition of hydrocarbon gases in vacuum followed by deposition of the carbon atoms to a substrate surface. This vapor phase condensation of cracked hydrocarbons is essentially a chemical vapor deposition (CVD) process. In particular, highly oriented pyrolytic graphite (HOPG) is the material produced by the application of uniaxial pressure on deposited pyrocarbon or pyrolytic graphite at very high temperatures (typically 3,000-3,300° C.). This entails a thermo-mechanical treatment of combined mechanical compression and ultra-high temperature for an extended period of time in a protective atmosphere; a very expensive, energy-intensive, and technically challenging process. This approach begins with a very expensive CVD process and ends with another very expensive process, requiring ultra-high temperature equipment (with high vacuum, high pressure, and/or high compression provision) that is not only very expensive to make but also very expensive and difficult to maintain.

Another prior art material for thermal management or EMI shielding application is the pyrolitic graphite film. The lower portion of FIG. 1(A) illustrates a typical process for producing prior art pyrolitic graphite films from a highly aromatic polymer. The process begins with carbonizing a polymer film 46 at a carbonization temperature of typically 400-1,500° C. under a typical pressure of 10-15 Kg/cm² for 6-36 hours to obtain a carbonized film 48, which is followed by a graphitization treatment at 2,500-3,200° C. under an ultrahigh pressure of 100-300 Kg/cm² for 5-36 hours, depending upon the graphitization temperature used to form a graphitic film 50. There are several major drawbacks associated with this process for producing graphitic films:
(1) Technically, it is utmost challenging to maintain such an ultrahigh pressure (>100 Kg/cm²) at such an ultrahigh temperature (>2,500° C.). The combined high temperature and high pressure conditions, even if achievable, are not cost-effective.
(2) This is a difficult, slow, tedious, energy-intensive, and very expensive process.
(3) This polymer carbonization and graphitization process typically is not conducive to the production of either thick graphitic films (>50 μm) or very thin films (<10 μm).
(4) In general, high-quality graphitic films could not be produced with a final graphitization temperature lower than 2,700° C., unless when a highly oriented polymer is used as a starting material, which is carbonized for an extended period of time prior to graphitization (e.g. please see Y. Nishikawa, et al. “Filmy graphite and process for producing the same,” U.S. Pat. No. 7,758,842 (Jul. 20, 2010)) or a catalytic metal is brought in contact with a highly oriented polymer during carbonization and graphitization (Y. Nishikawa, et al. “Process for producing graphite film,” U.S. Pat. No. 8,105,565 (Jan. 31, 2012)). This high degree of molecular orientation, as expressed in terms of optical birefringence, is not always possible to achieve. Further, the use of a catalytic metal tends to contaminate the resulting graphite films with metallic elements. Furthermore, the total heat treatment times (carbonization and graphitization combined) are too long and the amount of energy consumed is too high.
(5) The resulting graphitic films tend to be brittle and of low mechanical strength.

Thus, it is an object of the present invention to provide a process for producing graphitic films that exhibit a combination of exceptional thermal conductivity, electrical conductivity, and mechanical strength unmatched by any material of comparable thickness range.

Another object of the present invention is to provide a cost-effective process for producing a thermally conductive graphitic film from a polymer film or a nano graphene platelet-filled polymer through direct graphitization, without going through the pre-carbonization procedure.

In particular, the present invention provides a process capable of producing a graphitic film from a polymer film or a nano graphene platelet-filled polymer film at a graphitization temperature for a significantly shorter period of time than the total length of time required of conventional carbonization and graphitization procedures in order to successfully produce a graphitic film.

As compared to conventional processes, this inventive process involves significantly shorter heat treatment times and lower amounts of energy consumed, yet resulting in graphitic films that are of comparable or even higher thermal conductivity, higher electrical conductivity, and/or higher strength.

### SUMMARY OF THE INVENTION

This invention provides a one-step process for producing a highly conductive graphitic film having a thickness from 100 nm to 200 μm (preferably and more typically from 1 μm to 100 μm, and further more typically and preferably from 5 μm to 50 μm, and most typically from 10 μm to 25 μm). The process comprises directly feeding a precursor polymer film (or other carbon/graphite precursor film), without going through a carbonization step, to a graphitization zone (e.g. in a graphitization furnace) preset at a graphitization temperature no less than 2,200° C. (more typically no less than 2,500° C., further more typically no less than 2,800° C.) for a period of residence time sufficient for directly converting the precursor polymer film to a porous graphitic film having a density from 0.1 g/cm³ to 1.5 g/cm³ (more typically from 0.3 g/cm³ to 1.3 g/cm³, and most typically from 0.5 g/cm³ to 1.0 g/cm³) and then retreating the porous graphitic film from the graphitization zone. The precursor polymer film is preferably a high char-yield polymer selected from the group consisting of polyimide, polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polyacrylonitrile, and combinations thereof. In one embodiment, the precursor polymer film has a thickness from 1 μm to 100 μm, more preferably from 10 μm to 50 μm.

The process preferably further comprises a step of compressing (e.g. roll-pressing) the porous graphitic film to obtain a solid graphitic film having a physical density from 1.5 g/cm³ to 2.26 g/cm³, more typically at least 1.7 g/cm³, and most typically at least 1.9 g/cm³.

Preferably, the process is a continuous process that includes continuously or intermittently feeding the precursor polymer film from one end of the graphitization zone and retreating the porous graphitic film from another end of the graphitization zone (e.g. entering from one end of a graphitization furnace and leaving from another end of the furnace). Preferably, the graphitization zone is at least 5 meters long. In an embodiment, the graphitization zone is at a temperature no less than 2,750° C. and the residence time is from 3 hours to 12 hours.

Preferably, the precursor polymer film is under a compression stress while residing in the graphitization zone. In a preferred embodiment, the precursor polymer film is supported on a first refractory material plate and covered by a second refractory material plate to exert a compressive stress to the precursor polymer film while residing in the graphitization zone. The first refractory material or second refractory material may be selected from a thermally stable material, such as graphite, a refractory metal, or a carbide, oxide, boride, or nitride of a refractory metal element selected from tungsten, zirconium, tantalum, niobium, molybdenum, tantalum, or rhenium.

In a particularly advantageous embodiment, the precursor polymer film contains multiple sheets of a graphene material dispersed therein, wherein the graphene material is selected from pristine graphene, oxidized graphene, reduced graphene oxide, fluorinated graphene, hydrogenated graphene, doped graphene, chemically functionalized graphene, or a combination thereof, The graphene material can comprise a single-layer graphene sheet or a multi-layer graphene platelet with a thickness less than 10 nm. The graphene material can comprise a multi-layer graphene platelet with a thickness less than 4 nm. In a desired embodiment, the graphene material comprises a single-layer pristine graphene sheet or a multi-layer pristine graphene platelet with a thickness less than 10 nm and the pristine graphene sheet or pristine graphene platelet contains no oxygen and is produced from a process that does not involve oxidation.

In yet another embodiment, the precursor polymer film or other carbon/graphite precursor film contains expanded graphite flakes having a thickness greater than 100 nm.

In an embodiment, the precursor polymer can have a char yield of less than 50% (or even less than 40%, typically from 5% to 40%), if this polymer is reinforced with sheets of graphene or expanded graphite flakes (EP), as opposed to just the neat polymer alone.

When the graphitization temperature is less than 2,500° C., the resulting solid graphitic film typically has an inter-graphene spacing less than 0.337 nm (as determined by X-ray diffraction), a thermal conductivity of at least 1,200 W/mK, an electrical conductivity no less than 8,000 S/cm, a physical density greater than 1.9 g/cm³, and/or a tensile strength greater than 35 MPa. When the graphitization temperature is higher than 2,500° C., the resulting graphitic film typically has an inter-graphene spacing less than 0.336 nm, a thermal conductivity of at least 1,300 W/mK, an electrical conductivity no less than 10,000 S/cm, a physical density greater than 2.0 g/cm³, and/or a tensile strength greater than 40 MPa.

In an embodiment, the graphitic film exhibits an inter-graphene spacing less than 0.337 nm and a mosaic spread value less than 1.0. In another embodiment, the graphitic film exhibits a degree of graphitization no less than 60% and/or a mosaic spread value less than 0.7. In yet another embodiment, the graphitic film exhibits a degree of graphitization no less than 90% and/or a mosaic spread value less than 0.4.

The present invention also provides a graphitic film produced by the process as defined above. The invention also provides an electronic device containing such a graphitic film as a heat-dissipating element therein.

### BRIEF DESCRIPTION OF THE DRAWINGS

FIG. 1 (A) A flow chart illustrating various prior art processes of producing exfoliated graphite products (flexible graphite foils and flexible graphite composites) and pyrolytic graphite film (bottom portion); (B) Schematic drawing illustrating the processes for producing paper, mat, film, and membrane of simply aggregated graphite or NGP flakes/platelets.

FIG. 2 (A) A SEM image of a graphite worm sample after thermal exfoliation of graphite intercalation compounds (GICs) or graphite oxide powders; (B) An SEM image of a cross-section of a flexible graphite foil, showing many graphite flakes with orientations not parallel to the flexible graphite foil surface and also showing many defects, kinked or folded flakes.

FIG. 3 (A) A SEM image of a graphitic film derived from graphene sheet-PI composite; and (B) A SEM image of a cross-section of a graphene paper/film prepared from discrete graphene sheets/platelets using a paper-making process (e.g. vacuum-assisted filtration). This latter image shows many discrete graphene sheets being folded or interrupted (not integrated), with orientations not parallel to the film/paper surface and having many defects or imperfections.

FIG. 4 Chemical reactions associated with production of PBO.

FIG. 5 (A) The thermal conductivity values of a series of graphitic films derived from NGP-PBO films of various weight fractions of NGPs (from 0% to 100%); (B) The thermal conductivity values of a series of graphitic films derived from expanded graphite flake-PBO (EP-PBO) films of various weight fractions of NGPs; (C) Thermal conductivity comparison between graphitic films obtained from EP-PBO and NGP-PBO films (via direct graphitization).

FIG. 6 (A) Thermal conductivity and (B) electrical conductivity values of a series of graphitic films derived from NGP-PI films (66% NGP+34% PI), NGP paper alone, and PI film alone prepared under various heat treatment conditions (direct graphitization vs. carbonization+graphitization).

FIG. 7 (A) The thermal conductivity values of a series of graphitic films derived from NGP-PF films (90% NGP+10% PF), NGP paper alone, and PF film alone prepared at various final heat treatment temperatures, along with a curve of thermal conductivity according to the predictions of a rule-of-mixture law; (B) those derived from EP-PF films (90% EP+10% PF), EP paper alone, PF film alone, and theoretical predictions.

FIG. 8 The electric conductivity values of a series of graphitic films derived from NGP-PBI films of various weight fractions of NGPs (from 0% to 100%).

FIG. 9 The tensile strength values of NGP-PI derived films, PI-derived films, and NGP paper samples plotted as a function of the graphitization temperature.

### DESCRIPTION OF THE PREFERRED EMBODIMENTS

This invention provides a one-step process for producing a highly conductive graphitic film directly from either a neat polymer film (defined as a polymer having no filler dispersed therein) or a graphene sheet-reinforced polymer film, without having to go through a carbonization procedure prior to graphitization. In contrast, the carbonization procedure required in the prior art processes most typically involves a treatment of a neat polymer film at a carbonization temperature of 1,000-1,500° C. in a carbonization furnace for an extended period of time to form a porous, weak, and fragile carbon film that is difficult to handle. This porous carbon film is then retreated from the carbonization furnace and placed into a graphitization furnace, also for a long period of graphitization time. These prior art processes requiring both carbonization and graphitization are time-consuming and energy-intensive.

Alternatively, presumably one could use just a graphitization furnace, which also serves as a carbonization furnace. In other words, one could place a polymer film in such a furnace, wherein the furnace temperature is varied from near room temperature to a carbonization temperature and maintained at the carbonization temperature (e.g. 1,200° C.) for an extended period of time (6-36 hours) to form a porous carbon film. Subsequently, the temperature of the same furnace, containing the porous carbon film therein, is raised to a graphitization temperature (e.g. 2,850° C.) and maintained at this temperature for another long period of time (5-36 hours).

However, there are several problems associated with this alternative approach: All the ultra-high temperature furnaces (e.g. those for graphitization) suffer from significantly reduced operational life if they are subjected to repeated cooling and heating procedures. For instance, such an alternative approach involves cooling (e.g. from 2,850° C. to near room temperature or slightly above) to allow for retreating one batch of heat-treated film samples, introducing another batch, and then heating it back up to 2,850° C. to heat-treat this new batch of film samples. The need to repeatedly cool and heat a furnace over a wide temperature range also involves wasting tremendous amounts of energy. It takes time and extra energy to heat a furnace up to the graphitization temperature, and it also consumes extra time and energy (if faster cooling is desired) to cool it down.

It would be best to maintain a graphitization furnace at a graphitization temperature, never having to cool down this furnace (except for the purpose of conducting a periodic maintenance). With the prior art processes for producing graphitic films, this latter approach (of not involving repeated cooling and heating) has not been considered feasible. Contrarily, it is generally believed that one either has to use two separate furnaces (one for carbonization and the other for graphitization) to complete the graphitization of a polymer film or has to repeatedly cool down and heat up the same furnace for two-stage treatments (carbonization and graphitization) of a polymer film.

After extensive and in-depth studies, we have unexpectedly observed that one could use a single graphitization furnace preset at a desired graphitization temperature to successfully graphitize a polymer film (a neat polymer film having no additive dispersed therein, or a polymer composite film having graphene sheets or expanded graphite flakes as a dispersed additive). Such a direct graphitization strategy works well if the polymer has a relatively high char yield or carbon yield (e.g. >40%, preferably >50%). Examples of high char-yield polymers are polyimide, aromatic polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, and polyacrylonitrile.

If graphene sheets are used as an additive, even a low char-yield polymer film can be properly graphitized in a single-stage graphitization process (no separate carbonization) using a single graphitization furnace (without having to cool down and heat up the furnace to accommodate another batch of film samples). In fact, the precursor film does not have to be a polymer; it can be just a monomer, oligomer, aromatic organic, coal tar pitch, petroleum pitch, meso-phase pitch, etc. These are highly surprising research results and of high utility value. When graphene sheets are present, the minimum char yield appears to be approximately 5% (from 5% to 40%), but a preferred minimum char yield is approximately 20%.

With the presently invented process, the resulting graphitic film typically has a thickness from 100 nm to 200 μm (preferably and more typically from 1 μm to 100 μm, and further more typically and preferably from 5 μm to 50 μm, and most typically from 10 μm to 25 μm). The process comprises directly feeding a precursor polymer film (or other precursor material film, such as pitch or organic), without going through a carbonization step, to a graphitization zone (e.g. in a graphitization furnace) preset at a graphitization temperature no less than 2,200° C. (more typically no less than 2,500° C., further more typically no less than 2,800° C.) for a period of residence time sufficient for directly converting the precursor polymer film to a porous graphitic film having a density from 0.1 g/cm³ to 1.5 g/cm³ (more typically from 0.3 g/cm³ to 1.3 g/cm³, and most typically from 0.5 g/cm³ to 1.0 g/cm³) and then retreating the porous graphitic film from the graphitization zone. The precursor polymer film is preferably a high char-yield polymer (>40% char yield) selected from the group consisting of polyimide, polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polyacrylonitrile, and combinations thereof. In one embodiment, the precursor polymer film has a thickness from 1 μm to 100 μm, more preferably from 10 μm to 50 μm.

Preferably, the precursor polymer film (or other precursor material film) is under a compression stress while residing in the graphitization zone. For instance, this can be conducted by supporting the precursor polymer film on a first refractory material plate and covered by a second refractory material plate to exert a compressive stress to the precursor polymer film prior to placing the resulting sandwich structure into the furnace. This compression stress is maintained or slightly varied while the sandwich structure resides in the graphitization zone. The first refractory material or second refractory material may be selected from a thermally stable material, such as graphite, a refractory metal, or a carbide, oxide, boride, or nitride of a refractory metal element selected from tungsten, zirconium, tantalum, niobium, molybdenum, tantalum, or rhenium. Alternatively, one could place one or a plurality of polymer films, each separated by a plate of refractory material, in a mold (tool or crucible) and then place the mold in a graphitization furnace.

After the direct graphitization treatment, the resulting porous graphitic film is retreated from the furnace or from the graphitization zone. The process preferably further comprises a step of compressing (e.g. roll-pressing) the porous graphitic film to obtain a solid graphitic film having a physical density from 1.5 g/cm³ to 2.26 g/cm³, more typically greater than 1.7 g/cm³, and most typically greater than 1.9 g/cm³.

Preferably, the process is a continuous process that includes feeding the precursor polymer film from a first end of the graphitization zone, continuously or intermittently moving the film from this first end to a second end, and retreating the porous graphitic film from the second end of the graphitization zone (e.g. entering from one end of a graphitization furnace and leaving from another end of the furnace). Preferably, the graphitization zone is at least 5 meters long. In an embodiment, the graphitization zone is at a temperature no less than 2,750° C. and the residence time is from 3 hours to 12 hours.

The precursor polymer film may be a composite film, containing multiple sheets of a graphene material (having a thickness <100 nm, preferably <10 nm) or expanded graphite flakes (having a thickness >100 nm, by definition) dispersed in the polymer. The graphene material is selected from pristine graphene, oxidized graphene, reduced graphene oxide, fluorinated graphene, hydrogenated graphene, doped graphene, chemically functionalized graphene, or a combination thereof. The graphene material can comprise a single-layer graphene sheet or a multi-layer graphene platelet with a thickness less than 10 nm. The graphene material can comprise a multi-layer graphene platelet with a thickness less than 4 nm. In a desired embodiment, the graphene material comprises a single-layer pristine graphene sheet or a multi-layer pristine graphene platelet with a thickness less than 10 nm and the pristine graphene sheet or pristine graphene platelet contains no oxygen and is produced from a process that does not involve oxidation.

In an embodiment, the precursor matrix polymer of the composite can have a char yield of less than 50% (or even less than 40% or 20%), if this polymer is reinforced with sheets of a graphene material, as opposed to just the neat polymer alone. We have surprisingly observed that the presence of graphene sheets enable successful graphitization of those presumably non-graphitizable or low char-yield polymers. This is likely due to the notion that graphene sheets can serve as “crystal seeds” or nuclei from which graphite crystals are grown, obviating the need for pyrolyzed polymer structure to form nuclei that exceed critical sizes for crystal growth. Such a polymer structure (containing no graphene) requires a high char yield, normally greater than 50%, to be properly carbonized and graphitized.

When the graphitization temperature is less than 2,500° C., the resulting solid graphitic film typically has an inter-graphene spacing less than 0.337 nm (as determined by X-ray diffraction), a thermal conductivity of at least 1,200 W/mK, an electrical conductivity no less than 8,000 S/cm, a physical density greater than 1.9 g/cm3, and/or a tensile strength greater than 35 MPa. When the graphitization temperature is higher than 2,500° C., the resulting graphitic film typically has an inter-graphene spacing less than 0.336 nm, a thermal conductivity of at least 1,300 W/mK, an electrical conductivity no less than 10,000 S/cm, a physical density greater than 2.0 g/cm3, and/or a tensile strength greater than 40 MPa.

In an embodiment, the graphitic film exhibits an inter-graphene spacing less than 0.337 nm and a mosaic spread value less than 1.0. In another embodiment, the graphitic film exhibits a degree of graphitization no less than 60% and/or a mosaic spread value less than 0.7. In yet another embodiment, the graphitic film exhibits a degree of graphitization no less than 90% and/or a mosaic spread value less than 0.4.

The preparation of graphene materials and expanded graphite flakes is now described in details as follows:

The constituent graphene planes of a graphite crystallite can be exfoliated and extracted or isolated from a graphite crystallite to obtain individual graphene sheets of carbon atoms provided the inter-planar van der Waals forces can be overcome. An isolated, individual graphene sheet of carbon atoms is commonly referred to as single-layer graphene. A stack of multiple graphene planes bonded through van der Waals forces in the thickness direction with an inter-graphene plane spacing of 0.3354 nm is commonly referred to as a multi-layer graphene. A multi-layer graphene platelet has up to 300 layers of graphene planes (<100 nm in thickness), but more typically up to 30 graphene planes (<10 nm in thickness), even more typically up to 20 graphene planes (<7 nm in thickness), and most typically up to 10 graphene planes (commonly referred to as few-layer graphene in scientific community). Single-layer graphene and multi-layer graphene sheets are collectively called “nano graphene platelets” (NGPs). Graphene sheets/platelets or NGPs are a new class of carbon nano material (a 2-D nano carbon) that is distinct from the 0-D fullerene, the 1-D CNT, and the 3-D graphite. The graphene planes can be made to contain other elements, such as hydrogen, nitrogen, oxygen, and fluoride, to obtain hydrogenated graphene, nitrogenated graphene, graphene oxide, and graphene fluoride, as four examples of graphene materials.

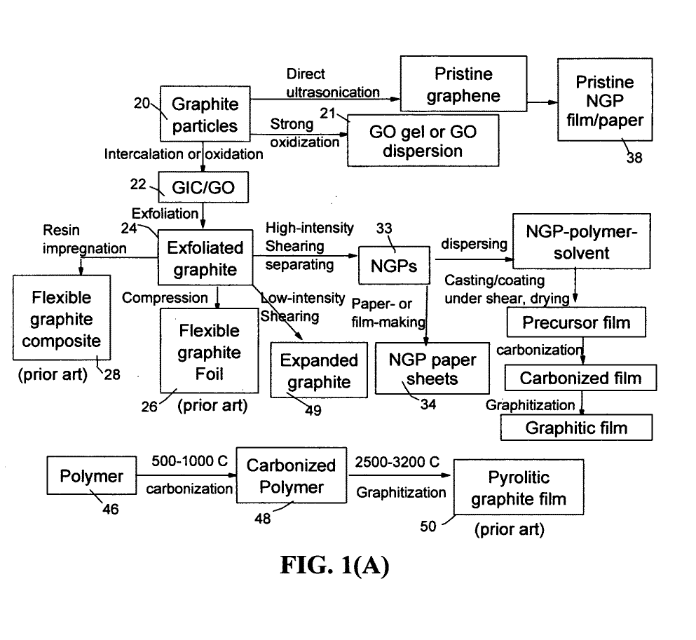

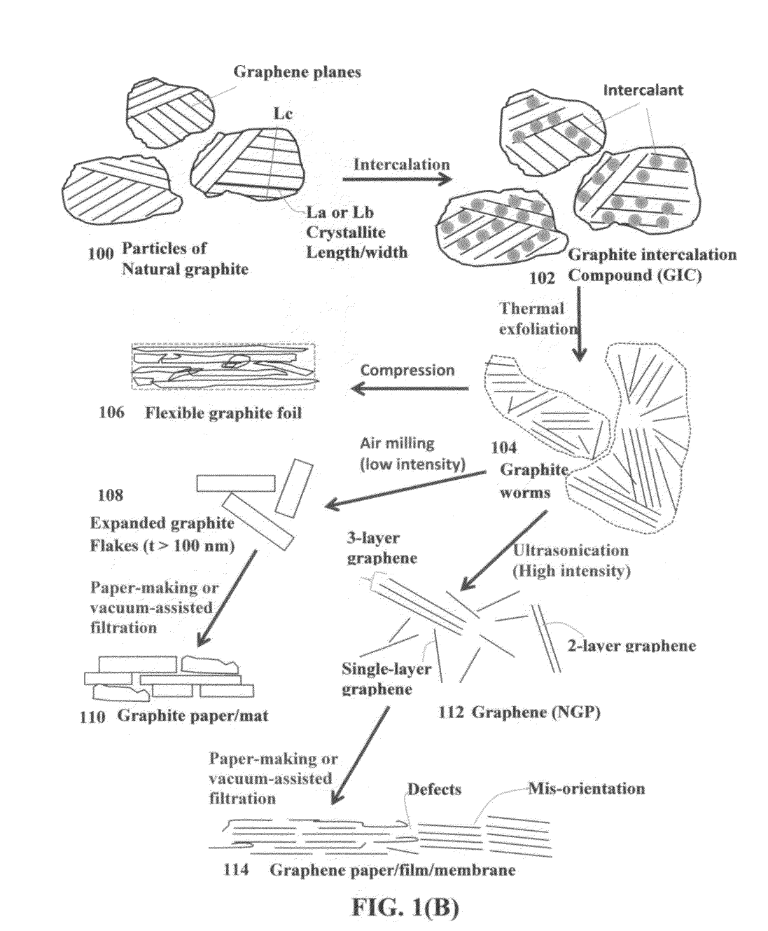

NGPs are typically obtained by intercalating natural graphite particles with a strong acid and/or oxidizing agent to obtain a graphite intercalation compound (GIC) or graphite oxide (GO), as illustrated in FIGS. 1(A) and 1(B). The presence of chemical species or functional groups in the interstitial spaces between graphene planes serves to increase the inter-graphene spacing (d₀₀₂, as determined by X-ray diffraction), thereby significantly reducing the van der Waals forces that otherwise hold graphene planes together along the c-axis direction. The GIC or GO is most often produced by immersing natural graphite powder (20 in FIG. 1(A)) in a mixture of sulfuric acid, nitric acid (an oxidizing agent), and another oxidizing agent (e.g. potassium permanganate or sodium perchlorate). The resulting GIC (22) is actually some type of graphite oxide (GO) particles. This GIC is then repeatedly washed and rinsed in water to remove excess acids, resulting in a graphite oxide suspension or dispersion, which contains discrete and visually discernible graphite oxide particles dispersed in water. There are two processing routes to follow after this rinsing step:

Route 1 involves removing water from the suspension to obtain “expandable graphite,” which is essentially a mass of dried GIC or dried graphite oxide particles. Upon exposure of expandable graphite to a temperature in the range of typically 800-1,050° C. for approximately 30 seconds to 2 minutes, the GIC undergoes a rapid expansion by a factor of 30-300 to form “graphite worms” (24), which are each a collection of exfoliated, but largely un-separated graphite flakes that remain interconnected.

In Route 1A, these graphite worms (exfoliated graphite or “networks of interconnected/non-separated graphite flakes”) can be re-compressed to obtain flexible graphite sheets or foils (26) that typically have a thickness in the range of 0.1 mm (100 μm)-0.5 mm (500 μm).

Alternatively, one may choose to use a low-intensity air jet mill or shearing machine to simply break up the graphite worms for the purpose of producing the so-called “expanded graphite flakes” which contain mostly graphite flakes or platelets thicker than 100 nm (hence, not a nano material by definition). Expanded graphite flakes may also be added to a polymer matrix material to make a composite film. Such an expanded graphite-polymer film can also be graphitized under comparable conditions as graphene-reinforced polymer composite film. However, the expanded graphite-polymer derived graphitic film exhibits a thermal conductivity and electrical conductivity lower than those of graphene sheet-reinforced polymer derived graphitic film having a comparable additive loading.

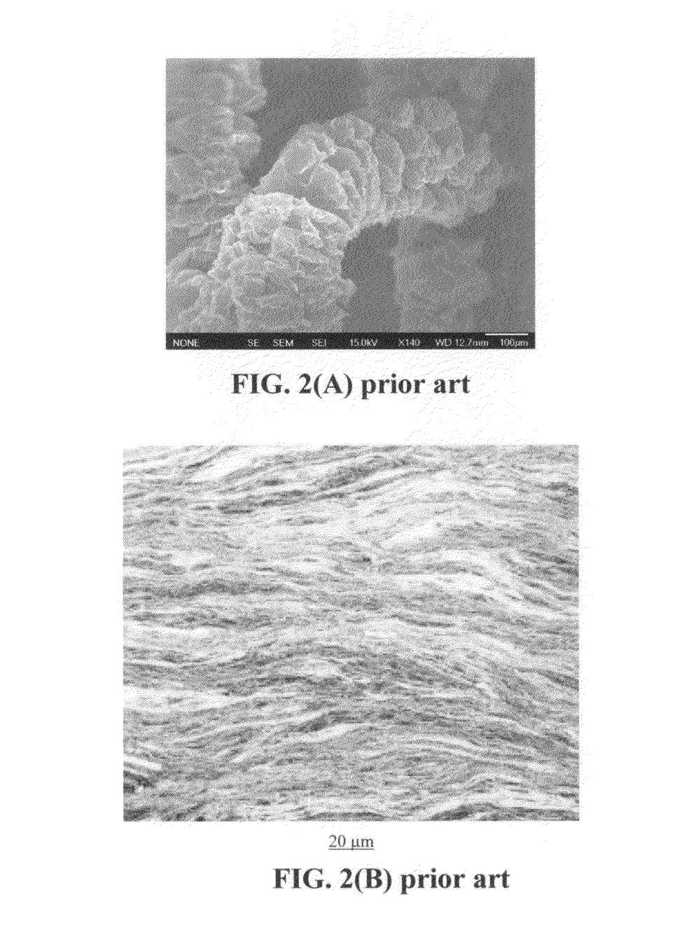

Exfoliated graphite worms, expanded graphite flakes, and the recompressed mass of graphite worms (commonly referred to as flexible graphite sheet or flexible graphite foil) are all 3-D graphitic materials that are fundamentally different and patently distinct from either the 1-D nano carbon material (CNT or CNF) or the 2-D nano carbon material (graphene sheets or platelets, NGPs). Flexible graphite (FG) foils can be used as a heat spreader material, but exhibiting a maximum in-plane thermal conductivity of typically less than 500 W/mK (more typically <300 W/mK) and in-plane electrical conductivity no greater than 1,500 S/cm. These low conductivity values are a direct result of the many defects, wrinkled or folded graphite flakes, interruptions or gaps between graphite flakes, and non-parallel flakes (e.g. SEM image in FIG. 2(B)). Many flakes are inclined with respect to one another at a very large angle (e.g. mis-orientation of 20-40 degrees).

In Route 1B, the exfoliated graphite is subjected to high-intensity mechanical shearing (e.g. using an ultrasonicator, high-shear mixer, high-intensity air jet mill, or high-energy ball mill) to form separated single-layer and multi-layer graphene sheets (collectively called NGPs, 33). Single-layer graphene can be as thin as 0.34 nm, while multi-layer graphene can have a thickness up to 100 nm. In the present application, the thickness of multi-layer NGPs is typically less than 20 nm.

Route 2 entails ultrasonicating the graphite oxide suspension for the purpose of separating/isolating individual graphene oxide sheets from graphite oxide particles. This is based on the notion that the inter-graphene plane separation bas been increased from 0.3354 nm in natural graphite to 0.6-1.1 nm in highly oxidized graphite oxide, significantly weakening the van der Waals forces that hold neighboring planes together. Ultrasonic power can be sufficient to further separate graphene plane sheets to form separated, isolated, or discrete graphene oxide (GO) sheets. These graphene oxide sheets can then be chemically or thermally reduced to obtain “reduced graphene oxides” (RGO) typically having an oxygen content of 0.001%-10% by weight, more typically 0.01%-5% by weight.

For the purpose of defining the claims of the instant application, NGPs include discrete sheets/platelets of single-layer and multi-layer versions of graphene, graphene oxide, or reduced graphene oxide with an oxygen content of 0-10% by weight, more typically 0-5% by weight, and preferably 0-2% by weight. Pristine graphene has essentially 0% oxygen. Graphene oxide (including RGO) typically has 0.001%-46% by weight of oxygen. NGPs or graphene materials can also include graphene fluoride, graphene chloride, graphene bromide, graphene iodide, nitrogenated graphene, hydrogenated graphene, doped graphene (e.g. boron-doped graphene), and functionalized graphene (e.g. amine-functionalized, polymer functionalized, etc.).

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension. A chemical blowing agent may then be dispersed into the dispersion (38 in FIG. 1(A)). This suspension is then cast or coated onto the surface of a solid substrate (e.g. glass sheet or Al foil). When heated to a desired temperature, the chemical blowing agent is activated or decomposed to generate volatile gases (e.g. N₂ or CO₂), which act to form bubbles or pores in an otherwise mass of solid graphene sheets, forming a pristine graphene foam 40a.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished.

Interaction of F₂ with graphite at high temperature leads to covalent graphite fluorides (CF)ₙ or (C₂F)ₙ, while at low temperatures graphite intercalation compounds (GIC) CₓF (2≦x≦24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultrasonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

The invention also provides a process for producing a highly conductive graphitic film from direct graphitization of a graphene-polymer composite, graphene-reinforced precursor composite (e.g. pitch matrix), expanded graphite flake-reinforced precursor, or expanded graphite flake-reinforced polymer composite film without going through a pre-carbonization procedure. In an embodiment, the process can begin with the step of combining graphene platelets or expanded graphite flakes with a carbon precursor material (e.g. a polymer, pitch, or organic material, etc.) and, if necessary, a liquid (e.g. water or other solvent) to obtain a composite film. This can be obtained, for instance, by mixing graphene sheets or exfoliated graphite flakes in a polymer-solvent solution to form a suspension or slurry, which is then cast or coated to become a thin film. This film is then solidified (e.g. cured or dried) to form a polymer composite film. The graphene platelets or expanded graphite flakes may occupy a weight fraction from 1% to 99% (preferably 5% to 90% by weight) based on the total precursor material (polymer) composite weight. The polymer composite film is then directly graphitized.

In an embodiment, the mixing step can be accomplished by dissolving a polymer in a solvent to form a solution and then dispersing graphene sheets or expanded graphite flakes in the solution to form a suspension or slurry. If the precursor material is in a monomer or oligomer form, or an organic material in a liquid state, then a solvent is not required. In this case, graphene sheets or expanded graphite flakes may be dispersed in the liquid to form a suspension. Typically, the polymer is in the amount of 0.1%-10% by weight in the polymer-solvent solution prior to mixing with graphene sheets or expanded graphite flakes. The graphene sheets or expanded graphite flakes may occupy 1% to 90% (more typically 10% to 90% and most desirably 50%-90%) by weight of the slurry.

The film-forming step can be conducted by casting or coating the slurry into a thin film on a solid substrate such as PET film. Without any additive, the neat resin (in a monomer, oligomer, or polymer state, the latter being dissolved in a solvent) can also be cast, sprayed, printed, or coated into a thin film. When graphene sheets or expanded graphite flakes are present in the suspension, the casting or coating procedure must include the application of a stress, typically containing a shear stress component, for the purpose of orienting the graphene sheets/platelets parallel to the thin film plane. In a casting procedure, this shear stress can be induced by running a casting guide (a “Doctor's blade”) over the cast slurry to form a thin film of desired thickness. In a coating procedure, the shear stress may be created by extruding the dispensed slurry through a coating die over the supporting PET substrate. Advantageously, the coating process can be a continuous, roll-to-roll process that is fully automated. The cast or coated film is initially in a wet state and the liquid component is substantially removed after coating or casting.

The polymer composite film is then directly placed in a graphitization furnace preset at a graphitization temperature >2,200° C. (more typically and preferably >2,500° C.). This step basically entails thermally converting the precursor material (e.g. polymer or organic material) of the composite film into a carbon matrix so that the resulting film is a graphene sheet-reinforced carbon matrix composite. A preferred group of carbon precursor materials contains polyimide (PI), polyamide, polyoxadiazole, polybenzoxazole, polybenzobisoxazole, polythiazole, polybenzothiazole, polybenzobisthiazole, poly(p-phenylene vinylene), polybenzimidazole, and polybenzobisimidazole. These polymers typically have a high carbon yield or char yield, having 50%-75% by weight of the material being retained as carbon (i.e. 25%-50% of non-carbon elements are removed during pyrolysis). Quite unexpectedly, these aromatic polymers can be directly graphitized without going through a pre-carbonization procedure.

Further unexpectedly, the presence of graphene platelets/sheets enables these aromatic polymers, other aromatic organic structures (e.g. coal tar pitch, petroleum pitch, meso-phase pitch, petroleum heavy oil, naphthalene, etc.), and other polymers having much lower char yield to be successfully graphitized without a pre-carbonization step. The graphene sheets appear to serve as preferential nucleation sites for graphite crystals.

Another surprising observation is that many other organic materials that are not known to be amenable to the formation of graphitic films or to graphitization can be successfully used as a precursor material to work with graphene sheets/platelets. These include, for instance, monomers or oligomers of the above-cited polymers (e.g. polyamic acid, a precursor to PI), low-carbon yield polymers (e.g. polyethylene oxide, polyvinyl chloride, epoxy resin, etc.), high-carbon yield polymers (e.g. phenolic resin), low molecular weight organic materials (e.g. maleic acid, naphthalene, etc.), and pitch (e.g. petroleum pitch, coal tar pitch, meso-phase pitch, heavy oil, etc.). The presence of graphene sheets or expanded graphite flakes appears to make some presumably low carbon-yield materials exhibit a higher carbon yield and make some previously non-graphitizable materials now graphitizable. Most significantly, these materials can be graphitized without a pre-carbonization step.

Thus, another embodiment of the present invention is a one-step process for producing a graphitic film, which process comprising directly feeding a precursor material film, without going through a carbonization step, to a graphitization zone preset at a graphitization temperature no less than 2,200° C. for a period of residence time sufficient for converting said precursor material film to a porous graphitic film having a density from 0.1 g/cm³ to 1.5 g/cm³ and retreating the porous graphitic film from the graphitization zone, wherein the precursor material film is selected from a petroleum pitch, coal tar pitch, meso-phase pitch, petroleum heavy oil, naphthalene, or organic material or polymer having a char yield less than 40% and wherein said precursor material film has an amount, from 1% to 99% by weight, of graphene material sheets or expanded graphite flakes dispersed therein

Most surprising is the observation that the graphite crystallites that are derived from the precursor polymer appear to be fully integrated with the pre-existing graphene sheets to seamlessly form a nearly perfect graphitic structure. No distinction can be identified between the original graphene sheets and the graphite crystallites that are formed through graphitization of the precursor material. One simply cannot tell if certain graphite crystals are from the original graphene sheets or from the subsequently graphitized precursor material. These observations were made through X-ray diffraction, SEM and TEM studies.

The graphene-precursor composite film may be subjected to direct graphitization at a graphitization temperature of 2,200° C.-3,200° C. At such a high temperature, nucleation of graphite crystals and growth of graphite crystals occur concurrently. The graphite crystals can be nucleated from the edges or surfaces of pre-existing graphene sheets or platelets that serve to bridge the gaps between original graphene sheets or platelets.

For the purpose of characterizing the structure of graphitic films, X-ray diffraction patterns were obtained with an X-ray diffractometer by the use of CuKcv radiation. The peak shift and broadening due to the diffractometer were calibrated using a silicon powder standard. The degree of graphitization, g, was calculated from the X-ray pattern using Mering's Eq, d₀₀₂=0.3354 g+0.344 (1-g), where d₀₀₂ is the interlayer spacing of graphite or graphene crystal in nm. This equation is valid only when d₀₀₂ is equal or less than approximately 0.3440 nm.

Another structural index that can be used to characterize the degree of ordering of the presently invented graphitic film derived from a graphene-reinforced precursor material or related graphite crystals is the “mosaic spread,” which is expressed by the full width at half maximum of an X-ray diffraction intensity curve representing the (002) or (004) reflection. This degree of ordering characterizes the graphite crystal size (or grain size), amounts of grain boundaries and other defects, and the degree of preferred grain orientation. A nearly perfect single crystal of graphite is characterized by having a mosaic spread value of 0.2-0.4. Most of our graphitic films have a mosaic spread value in this range of 0.2-0.4 (when obtained with a heat treatment temperature no less than 2,500° C.). However, some values are in the range of 0.4-0.7 if the graphitization is between 2,200 and 2,500° C.

The present invention also provides a graphitic film produced by the process as defined above. The invention also provides an electronic device containing such a graphitic film as a heat-dissipating element therein.

The following examples are presented to illustrate the best modes of practicing the instant invention, and not to be construed as limiting the scope of the instant invention:

### Example 1

### Preparation of Discrete Graphene Sheets (Nano Graphene Platelets, or NGPs) and Expanded Graphite Flakes

Natural graphite powder with an average lateral dimension of 45 μm was used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 16 hours of reaction, the acid-treated natural graphite particles were filtered and washed thoroughly with deionized water until the pH level of the solution reached 4.0. After being dried at 100° C. overnight, the resulting graphite intercalation compound (GIC) was subjected to a thermal shock at 1050° C. for 45 seconds in a tube furnace to form exfoliated graphite (or graphite worms).

Five grams of the resulting exfoliated graphite (graphite worms) were mixed with 2,000 ml alcohol solution consisting of alcohol and distilled water with a ratio of 65:35 for 2 hours to obtain a suspension. Then the mixture or suspension was subjected to ultrasonic irradiation with a power of 200 W for various times. After two intermittent sonication treatments each of 1.5 hours, EG particles were effectively fragmented into thin NGPs. The suspension was then filtered and dried at 80° C. to remove residue solvents. The as-prepared NGPs (thermally reduced GO) have an average thickness of approximately 3.4 nm.

Another five grams of the resulting exfoliated graphite worms were subjected to low-intensity air jet milling to break up graphite worms, forming expanded graphite flakes (having an average thickness of 139 nm).

### Example 2

### Preparation of Single-Layer Graphene Sheets from Meso-Carbon Micro-Beads (MCMBs)

Meso-carbon microbeads (MCMBs) were supplied from China Steel Chemical Co. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 72 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was neutral. The slurry was dried and stored in a vacuum oven at 60° C. for 24 hours. The dried powder sample was placed in a quartz tube and inserted into a horizontal tube furnace pre-set at a desired temperature, 1,080° C. for 45 seconds to obtain a graphene material. TEM and atomic force microscopic studies indicate that most of the NGPs were single-layer graphene.

### Example 3

### Preparation of Pristine Graphene Sheets/Platelets

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of graphene sheets for a period of 15 minutes to 2 hours.

### Example 4

### Preparation of Graphene Fluoride Nano Sheets

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion of few-layer graphene fluoride, but longer sonication times ensured the production of mostly single-layer graphene fluoride sheets. Some of these suspension samples were subjected to vacuum oven drying to recover separated graphene fluoride sheets. These graphene fluoride sheets were then added into a polymer-solvent or monomer-solvent solution to form a suspension. Various polymers or monomers (or oligomers) were utilized as the precursor film materials for subsequent direct graphitization or, for comparison purposes, for subsequent carbonization and graphitization treatments.

Upon casting on a glass surface with the solvent removed, the dispersion became a brownish film formed on the glass surface. When these GF-reinforced polymer films were heat-treated, fluorine and other non-carbon elements were released as gases that generated pores in the film. The resulting porous graphitic films had physical densities from 0.33 to 1.22 g/cm³. These porous graphitic films were then roll-pressed to obtain solid graphitic films having a density from 1.8 to 2.2 g/cm³.

### Example 5

### Preparation of Nitrogenataed Graphene Nano Sheets

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene:urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenataed graphene sheets remain dispersible in water. Two types of dispersions were then prepared. One involved adding water-soluble polymer (e.g. polyethylene oxide) into the nitrogenated graphene sheet-water dispersion to produce a water-based suspension. The other involved drying the nitrogenated graphene sheet-water dispersion to recover nitrogenated graphene sheets, which were then added into precursor polymer-solvent solutions to obtain organic solvent-based suspensions.

The resulting suspensions were then cast, dried, and then either directly graphitized or carbonized and then graphitized. The carbonization temperatures for comparative samples are 900-1,350° C. The graphitization temperatures are from 2,200° C. to 2,950° C.

### Example 6

### Preparation of Polybenzoxazole (PBO) Films, Graphene (NGP)-PBO Films, and Expanded Graphite Flake-PBO Films

Polybenzoxazole (PBO) films were prepared via casting and thermal conversion from its precursor, methoxy-containing polyaramide (MeO-PA). Specifically, monomers of 4,4′-diamino-3,3′-dimethoxydiphenyl (DMOBPA), and isophthaloyl dichloride (IPC) were selected to synthesize PBO precursors, methoxy-containing polyaramide (MeO-PA) solution. This MeO-PA solution for casting was prepared by polycondensation of DMOBPA and IPC in DMAc solution in the presence of pyridine and LiCl at −5° C. for 2 hr, yielding a 20 wt % pale yellow transparent MeO-PA solution. The inherent viscosity of the resultant MeO-PA solution was 1.20 dL/g measured at a concentration of 0.50 g/dl at 25° C. This MeO-PA solution was diluted to a concentration of 15 wt % by DMAc for casting.

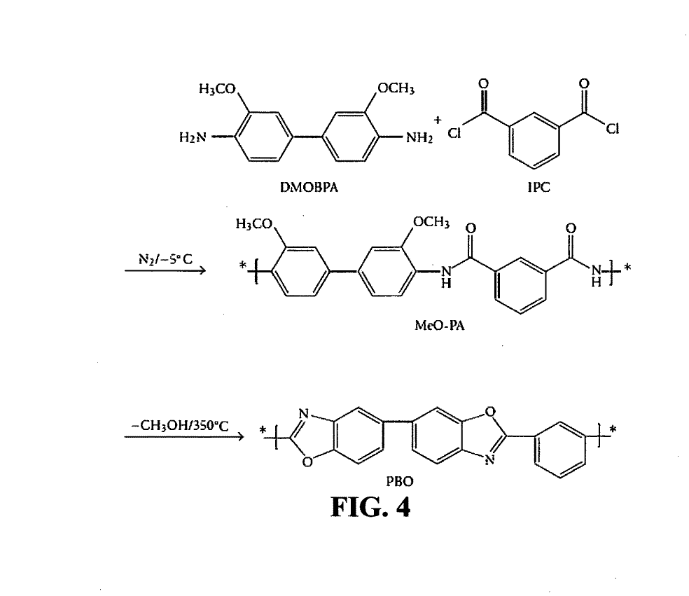

The as-synthesized MeO-PA was cast onto a glass surface to form thin films (35-120 μm) under a shearing condition. The cast film was dried in a vacuum oven at 100° C. for 4 hr to remove the residual solvent. Then, the resulting film having a thickness of approximately 28-100 μm was treated at 200° C.-350° C. under N₂ atmosphere in three steps and annealed for about 2 hr at each step. This heat treatment serves to thermally convert MeO-PA into PBO films. The chemical reactions involved may be illustrated in FIG. 4. For comparison, both graphene (NGP)-PBO and expanded graphite flake (EP)-PBO films were made under similar conditions. The graphene sheet or EP flake proportions were varied from 10% to 90% by weight.

For comparison purposes, selected film samples were pressed between two plates of alumina while being carbonized under a 3-sccm argon gas flow in three steps: from room temperature to 600° C. in 1 h, from 600 to 1,000° C. in 1.5 h, and maintained at 1,000° C. for 5 hours. The carbonized films were then roll-pressed in a pair of rollers to reduce the thickness by approximately 40%. The roll-pressed films were then subjected to graphitization treatments at 2,200° C. for 5 hours, followed by another round of roll-pressing to reduce the thickness by typically 20-40%. For direct graphitization samples, there was no carbonization step, and the samples were directly placed in a furnace pre-set at 2,200° C. and maintained at this temperature for 5 hours before the furnace was cooled down and samples retreated.

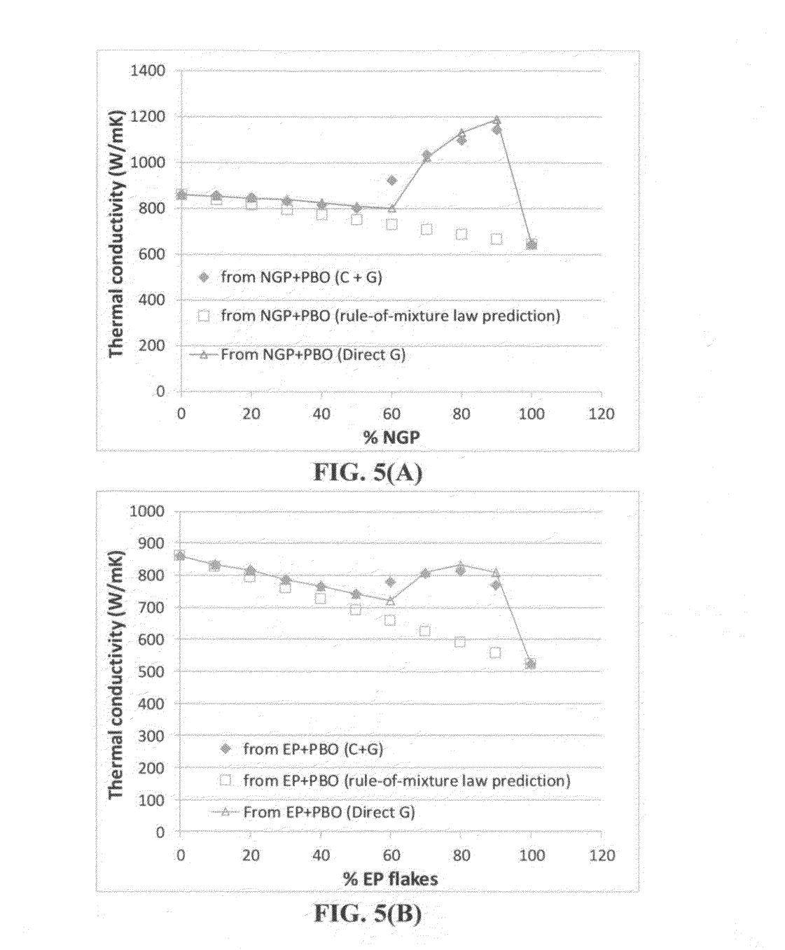

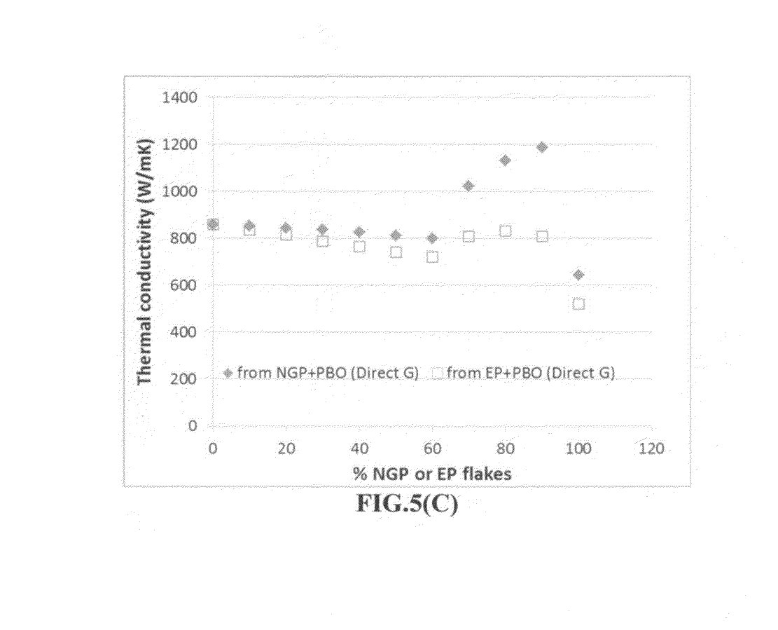

The thermal conductivity values of a series of graphitic films derived from NGP-PBO films of various NGP (graphene material) weight fractions (from 0% to 100%) prepared under different processing conditions (direct graphitization and “carbonization+graphitization”) are summarized in FIG. 5(A). Also plotted therein is a curve of thermal conductivity (K_{c}) according to the theoretical predictions of a rule-of-mixture law commonly used to predict the property of a composite consisting of two components A and B having thermal conductivity of K_{A} and K_{B}, respectively: K_{c}=w_{A} K_{A}+w_{B} K_{B}, where w_{A}=weight fraction of component A and w_{B}=weight fraction of component B, and w_{A}+w_{B}=1. In the present case, w_{B}=weight fraction of NGPs, varying from 0% to 100%. The sample containing 100% NGPs was prepared by a well-known vacuum-assisted filtration procedure for making graphene paper, which was also allowed to undergo the same heat treatment and roll-pressing procedures. Several observations can be made by examining these data:
(A) The data clearly indicate that direct graphitization (without carbonization) leads to graphitic films exhibiting comparable or even better thermal conductivity as compared to the graphitic films prepared through combined carbonization and graphitization. Yet, the direct graphitization requires a significantly shorter period of time (shorter by as much as 36 hours) and consumes a significantly lesser amount of energy.
(B) For both direct graphitization and combined carbonization/graphitization approaches, the approach of adding graphene sheets into a precursor polymer matrix led to unexpected synergism, having all thermal conductivity values drastically higher than those theoretically predicted based on the rule-of-mixture law.
(C) Further significantly and unexpectedly, some thermal conductivity values are higher than those of both the film derived from PBO alone (860 W/mK) and the film (paper) derived from graphene sheets alone (645 W/mK). With 60-90% NGP (graphene sheets) in the precursor composite film, the thermal conductivity values of the final graphitic films are above 860 W/mK, the better (higher) of the two.
(D) Quite interestingly, the neat PBO-derived graphitic films prepared under identical conditions exhibit a highest conductivity value of 860 W/mK, yet several combined NGP-PBO films, when carbonized and graphitized, exhibit thermal conductivity values of 924-1,145 W/mK. When directly graphitized, the thermal films derived from PBO-NGP exhibit a thermal conductivity as high as 1,200 W/mK.

These surprisingly observed synergistic effects might be due to the notions that graphene sheets could promote graphitization of the heat-treated precursor material (e.g. PBO film), and that the newly graphitized phase from PBO could help fill the gaps between otherwise separated discrete graphene sheets. Graphene sheets are themselves a highly graphitic material, better organized or graphitized than the graphitized polymer itself. Without the newly formed graphitic domains that bridge the gaps between graphene sheets, the transport of electrons and phonons would have been interrupted and would have resulted in lower conductivity. This is why the thin film paper made from NGPs alone exhibits a conductivity of only 645 W/mK.

The thermal conductivity values of a series of graphitic films derived from EP-PBO films of various weight fractions of expanded graphite flakes (EP, from 0% to 100%) are summarized in FIG. 5(B). Again, direct graphitization gives rise to a graphitic film as good as conventional combined carbonization/graphitization treatments that are otherwise dramatically more time-consuming and energy intensive. Also plotted therein is a curve of thermal conductivity (K_{c}) according to the theoretical predictions of a rule-of-mixture law. The data also show that the approach of adding expanded graphite flakes into a precursor polymer film has led to synergism, having all thermal conductivity values higher than the rule-of-mixture law predictions. However, as re-plotted in FIG. 5(C), these deviations from the theoretical predictions are not as dramatic as those in NGP-filled counterparts. This is quite surprising by itself since expanded graphite flakes (>100 nm in thickness) are actually quite graphitic, no less graphitic or organized than graphene sheets (typically 0.34-10 nm thick). This might be due to graphene sheets being more readily oriented during the film-forming procedure as compared to expanded graphite flakes. Additionally, graphene sheets might also be more effective than expanded graphite flakes in promoting graphitization of the precursor material; e.g. being more effective heterogeneous nucleating sites for graphite crystals.

### Example 7

### Preparation of Polyimide (PI) Films, NGP-PI Films, and their Heat Treated Versions

The synthesis of conventional polyimide (PI) involved poly(amic acid) (PAA, Sigma Aldrich) formed from pyromellitic dianhydride (PMDA) and oxydianiline (ODA). Prior to use, both chemicals were dried in a vacuum oven at room temperature. Then, 4 g of the monomer ODA was dissolved into 21 g of DMF solution (99.8 wt %). This solution was stored at 5° C. before use. PMDA (4.4 g) was added, and the mixture was stirred for 30 min using a magnetic bar. Subsequently, the clear and viscous polymer solution was separated into four samples. Triethyl amine catalyst (TEA, Sigma Aldrich) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential to further processing.

Solvents utilized in the poly(amic acid) synthesis are an important consideration. Common dipolar aprotic amide solvents utilized are DMF, DMAc, NMP and TMU. DMAc was a preferred solvent utilized in the present study. The intermediate poly(amic acid) and NGP-PAA precursor composite were converted to the final polyimide by the thermal imidization route. Films were first cast on a glass substrate and then allowed to proceed through a thermal cycle with temperatures ranging from 100° C. to 350° C. The procedure entails heating the poly(amic acid) mixture to 100° C. and holding for one hour, heating from 100° C. to 200° C. and holding for one hour, heating from 200° C. to 300° C. and holding for one hour and slow cooling to room temperature from 300° C.

The PI films, pressed between two alumina plates, were heat-treated under a 3-sccm argon gas flow at 1000° C. This occurred in three steps: from room temperature to 600° C. in 1 h, from 600 to 1,000° C. in 2 h, and 1,000° C. maintained for 5 h. The carbonized samples were then graphitized. Separately, selected samples were subjected to direct graphitization without a pre-carbonization treatment. The graphitization or direct graphitization temperatures were varied from 2,200 to 2,950° C.

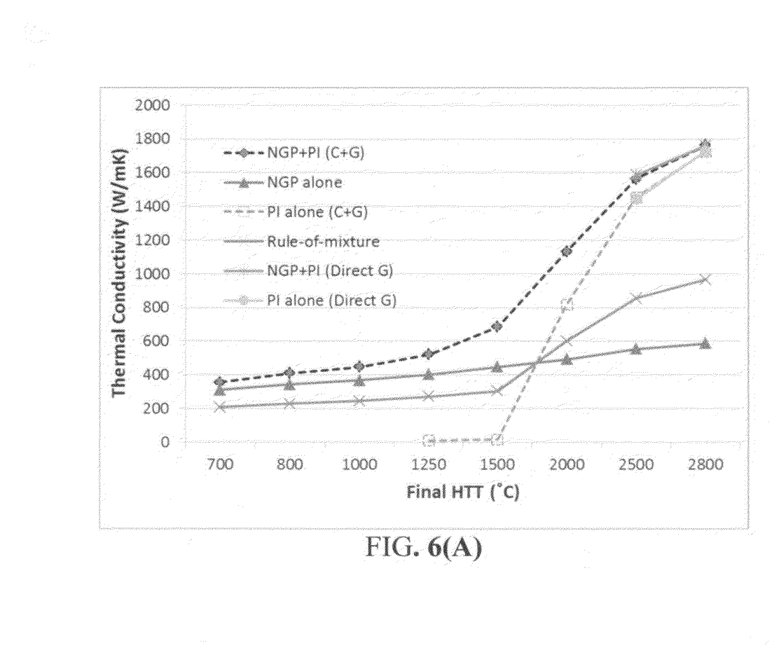

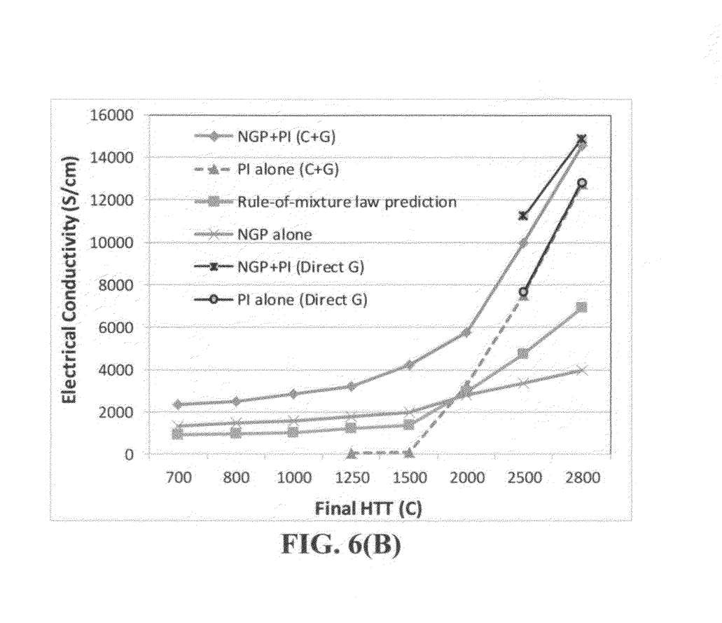

The thermal conductivity and electrical conductivity values of a series of graphitic films derived from NGP-PI films (66% NGP+34% PI), NGP paper alone, and PI film alone each prepared under various heat treatment conditions are summarized in FIG. 6(A) and FIG. 6(B), respectively. Also plotted in each figure is a curve of thermal conductivity (K_{c}) or electrical conductivity curve according to the predictions of a rule-of-mixture law. These data clearly demonstrate that direct graphitization (without carbonization) leads to graphitic films exhibiting comparable or even better thermal conductivity as compared to the graphitic films prepared through combined carbonization and graphitization. Yet, the direct graphitization requires a significantly shorter period of time and consumes a significantly lesser amount of energy. The data also demonstrate that the approach of incorporating graphene sheets in a precursor material (PI) has led to synergism, having all thermal and electrical conductivity values higher than the rule-of-mixture law predictions. Not just thermal conductivity, but also electrical conductivity can be significantly improved.

### Example 8

### Preparation of Phenolic Resin, NGP-Phenolic Films, and their Heat-Treated Versions

Phenol formaldehyde resins (PF) are synthetic polymers obtained by the reaction of phenol or substituted phenol with formaldehyde. The PF resin, alone or with up to 90% by weight NGPs or expanded graphite (EP) flakes, was made into 50-μm thick film and cured under identical curing conditions: a steady isothermal cure temperature at 100° C. for 2 hours and then increased from 100 to 170° C. and maintained at 170° C. to complete the curing reaction.

Some of the thin films were then subjected to direct graphitization at two different temperatures (2,500 and 2,800° C.) for 6 hours. For comparison, other thin films were carbonized at 500° C. for 2 hours, at 700° C. for 3 hours, and at 1,000° C. for 3 hours. The carbonized films were then subjected to further heat treatments (graphitization) at temperatures that were varied from 1,500 to 2,800° C. for 6-10 hours.

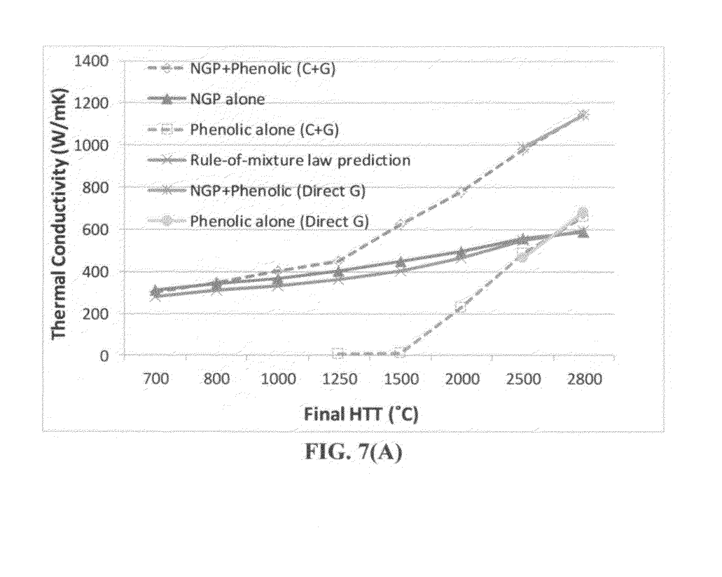

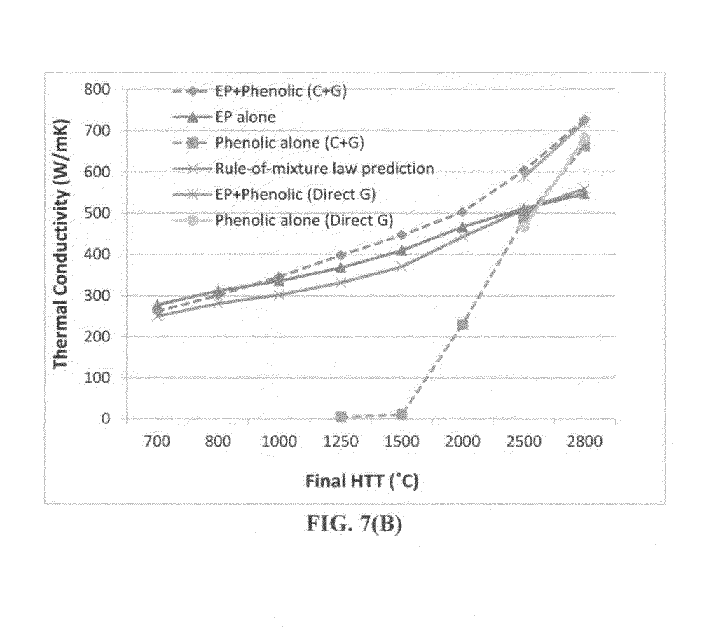

The thermal conductivity values of a series of graphitic films derived from NGP-PF films (e.g. 90% NGP+10% PF), NGP paper alone, and PF film alone prepared at various final heat treatment temperatures are summarized in FIG. 7(A). Also plotted therein is a curve of thermal conductivity (K_{c}) according to the predictions of a rule-of-mixture law. It is clear that direct graphitization is a much preferred process to combined carbonization/graphitization treatments since it provides comparable graphic films at a much faster production rate and much lower energy consumption. Again, the data show that the approach of incorporating graphene sheets and a graphite precursor (PF) has led to synergism, having all thermal conductivity values much higher than the rule-of-mixture law predictions.

The thermal conductivity values of a series of graphitic films derived from expanded graphite flake (EP)-PF films (90% EP+10% PI), EP paper alone, and PF film alone prepared at various final heat treatment temperatures are summarized in FIG. 7(B). Also plotted therein is a curve of thermal conductivity (Kᵤ) according to the predictions of a rule-of-mixture law. The data show that the approach of combining expanded graphite flakes and a carbon precursor (PF) has led to synergism, having all thermal conductivity values higher than the rule-of-mixture law predictions. However, as re-plotted in FIG. 7(C), these deviations from the theoretical predictions are not as dramatic as those in NGP-filled counterparts. Again, this is quite surprising by itself since expanded graphite flakes are actually quite graphitic, no less graphitic or organized than graphene sheets. This might be due to graphene sheets being more readily oriented during the film-forming procedure as compared to expanded graphite flakes. Additionally, graphene sheets might also be more effective than expanded graphite in promoting graphitization of the carbonized precursor material; e.g. being more effective heterogeneous nucleating sites for graphite crystals during graphitization of the carbonized resin.

### Example 9

### Preparation of Polybenzimidazole (PBI) Films and NGP-PBI Films

PBI is prepared by step-growth polymerization from 3,3′,4,4′-tetraaminobiphenyl and diphenyl isophthalate (an ester of isophthalic acid and phenol). The PBI used in the present study was obtained from PBI Performance Products in a PBI solution form, which contains 0.7 dl/g PBI polymer dissolved in dimethylacetamide (DMAc). The PBI and NGP-PBI films were cast onto the surface of a glass substrate. The heat treatment and roll-pressing procedures were similar to those used in Example 7 for PBO.

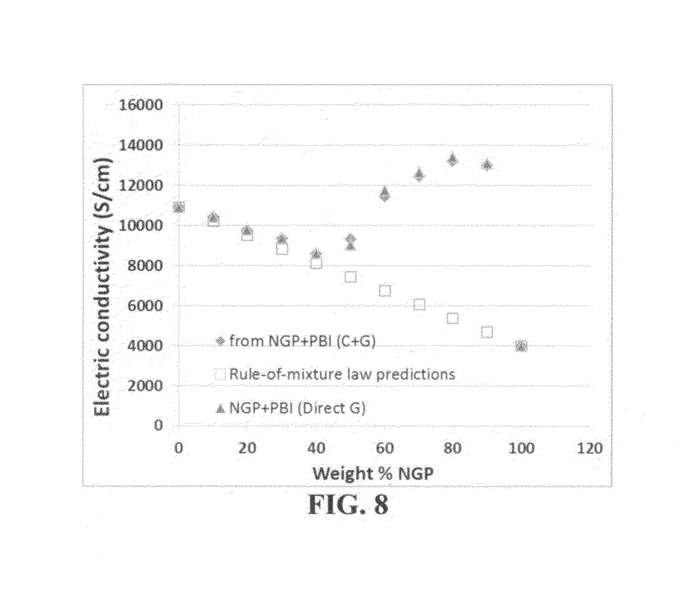

The electric conductivity values of a series of graphitic films derived from NGP-PBI films of various weight fractions of NGPs (from 0% to 100%) are summarized in FIG. 8. Also plotted therein is a curve of electric conductivity (σ_{c}) according to the predictions of a rule-of-mixture law commonly used to predict the property of a composite consisting of two components A and B having electric conductivity of σ_{A} and σ_{B}, respectively: σ_{c}=w_{A} σ_{A}+w_{B} σ_{B}, where w_{A}=weight fraction of component A and w_{B}=weight fraction of component B, and w_{A}+w_{B}=1. In the present case, w_{B}=weight fraction of NGPs, varying from 0% to 100%. The sample containing 100% NGPs was prepared by a well-known vacuum-assisted filtration procedure for making graphene paper which also underwent the same heat treatment and roll-pressing procedures.

The data further validates the presently invented direct graphitization strategy in terms of producing superior graphitic films from a polymer film without going through a tedious and energy intensive carbonization stage. The data clearly demonstrate that the approach of combining NGP and a precursor material, followed by direct graphitization, led to dramatic synergism, having all electric conductivity values drastically higher than those theoretically predicted based on the rule-of-mixture law. Further unexpectedly, some electric conductivity values are higher than those of both the film derived from PBI alone (10,900 S/cm) and the paper derived from graphene sheets alone (3,997 S/cm). With 60-90% NGP in the precursor composite film, the electric conductivity values of the final graphitic films are above 10,900 S/cm, the better (higher) of the two. Quite interestingly, even though the neat PBI-derived graphitic films prepared under identical conditions exhibit a highest conductivity value of 10,900 S/cm, several combined NGP-PBI films, upon direct graphitization, exhibit electric conductivity values of 11,755-13,435 S/cm.

### Example 10

### Graphitic Films from Various NGP-Modified Carbon/Graphite Precursors

Additional graphitic films are prepared from several different types of precursor materials. Their electric and thermal conductivity values are listed in Table 1 below. These data further confirm that direct graphitization is a superior process for producing superior graphitic films from graphene-reinforced precursor materials.

TABLE 1
Preparation conditions and properties of graphitic films from other precursor materials

| | | | | | Electric | Thermal |
|---|---|---|---|---|---|---|
| Sample | | Carbon | Carbonization | Graphitization | conduc. | conduc. |
| No. | NGP or EP | Precursor | temperature | temperature | (S/cm) | (W/mK) |
| 8-A | Pristine | Petroleum | 600-1000° C. | 2,300° C. | 8,300 | 950 |
| | graphene, 80% | pitch | | | | |
| 8-B | Pristine | Petroleum | none | 2,300 | 8,350 | 953 |
| | graphene, 80% | pitch | | | | |
| 8-C | EP, 80% | Coal tar | 600-1000° C. | 2,300 | 6,776 | 766 |
| | | pitch | | | | |
| 8-D | EP, 80% | Coal tar | none | 2,300 | 6,770 | 765 |
| | | pitch | | | | |
| 9-A | Reduced GO, | Naphthalene | 600-1000° C. | 2,300 | 7,322 | 855 |
| | 80% | | | | | |
| 9-B | Reduced GO, | Naphthalene | none | 2,300 | 7,330 | 860 |
| | 80% | | | | | |
| 10-A | Fluorinated | PAN | 230, 600, | 2,500 | 7,007 | 820 |
| | graphene, 50% | | 1000° C. each 1 hr | | | |
| 10-B | Fluorinated | PAN | none | 2,500 | 7,011 | 825 |
| | graphene, 50% | | | | | |
| 10-C | Fluorinated | None | 230, 600, | 2,500 | 3,233 | 520 |
| | graphene paper | | 1000° C. each 1 hr | | | |
| 11-A | Nitrogenated | Polyamide | 600-1,500° C. | 2,800 | 9,540 | 1,050 |
| | graphene, 85% | | | | | |
| 11-B | Nitrogenated | Polyamide | none | 2,800 | 9,550 | 1,065 |
| | graphene, 85% | | | | | |

### Example 11

### Characterization of Graphitic Films

X-ray diffraction curves of a carbonized or graphitized material were monitored as a function of the heat treatment temperature and time. The peak at approximately 2θ=22-23° of an X-ray diffraction curve corresponds to an inter-graphene spacing (d₀₀₂) of approximately 0.3345 nm in natural graphite. With some heat treatment at a temperature >1,500° C. of a carbonized aromatic polymer, such as PI, PBI, and PBO, the material begins to see diffraction curves exhibiting a peak at 2θ<12° C. The angle 2θ shifts to higher values when the graphitization temperature and/or time are increased. With a heat treatment temperature of 2,500° C. for 1-5 hours (in a direct graphitization process or combined carbonization/graphitization procedures), the d₀₀₂ spacing typically is decreased to approximately 0.336 nm, close to 0.3354 nm of a graphite single crystal.

With a heat treatment temperature of 2,750° C. for 5 hours, the d₀₀₂ spacing is decreased to approximately to 0.3354 nm, identical to that of a graphite single crystal. In addition, a second diffraction peak with high intensity appears at 2θ=55°, corresponding to X-ray diffraction from (004) plane. The (004) peak intensity relative to the (002) intensity on the same diffraction curve, or the I(004)/I(002) ratio, is a good indication of the degree of crystal perfection and preferred orientation of graphene planes.

The (004) peak is either non-existing or relatively weak, with the I(004)/I(002) ratio <0.1, for all graphitic materials obtained from neat matrix polymers (containing no dispersed NGPs) via heat treating at a final temperature lower than 2,800° C. For these materials, the I(004)/I(002) ratio for the graphitic materials obtained by heat treating at 3,000-3,250° C. is in the range of 0.2-0.5. In contrast, a graphitic film prepared from a NGP-PI film (90% NGP) with a HTT of 2,750° C. for 3 hours exhibits a I(004)/I(002) ratio of 0.78 and a Mosaic spread value of 0.21, indicating a practically perfect graphene single crystal with an exceptional degree of preferred orientation.

The “mosaic spread” value is obtained from the full width at half maximum of the (002) reflection in an X-ray diffraction intensity curve. This index for the degree of ordering characterizes the graphite or graphene crystal size (or grain size), amounts of grain boundaries and other defects, and the degree of preferred grain orientation. A nearly perfect single crystal of graphite is characterized by having a mosaic spread value of 0.2-0.4. Most of our NGP-PI derived materials have a mosaic spread value in this range of 0.2-0.4 (if obtained with a heat treatment temperature no less than 2,200° C.). It may be noted that the I(004)/I(002) ratio for flexible graphite foil are typically <<0.05, practically non-existing in most cases. The I(004)/I(002) ratio for all NGP paper/membrane samples is <0.1 even after a heat treatment at 3,000° C. for 2 hours.

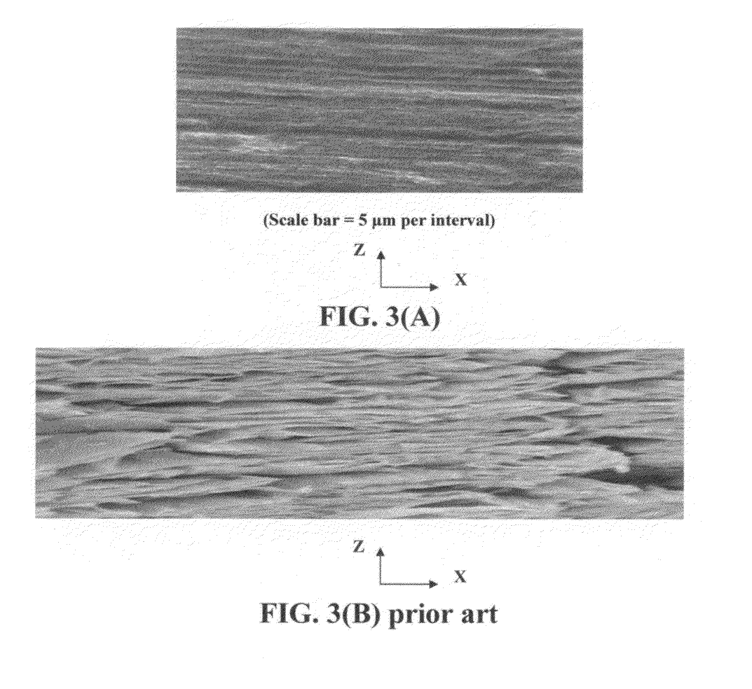

Scanning electron microscopy (SEM), transmission electron microscopy (TEM) pictures of lattice imaging of the graphene layer, as well as selected-area electron diffraction (SAD), bright field (BF), and dark-field (DF) images were also conducted to characterize the structure of various graphitic film materials. A close scrutiny and comparison of FIGS. 2(A), 3(A), and 3(B) indicates that the graphene layers in a graphitic film herein invented are substantially oriented parallel to one another; but this is not the case for flexible graphite foils and NGP paper. The inclination angles between two identifiable layers in the inventive graphitic films are mostly less than 5 degrees. In contrast, there are so many folded graphite flakes, kinks, and mis-orientations in flexible graphite that many of the angles between two graphite flakes are greater than 10 degrees, some as high as 45 degrees (FIG. 2(B)). Although not nearly as bad, the mis-orientations between graphene platelets in NGP paper (FIG. 3(B)) are also high and there are many gaps between platelets. Most significantly, the inventive graphitic films are essentially gap-free.

### Examples 12

### Tensile Strength of Various Graphitic Films

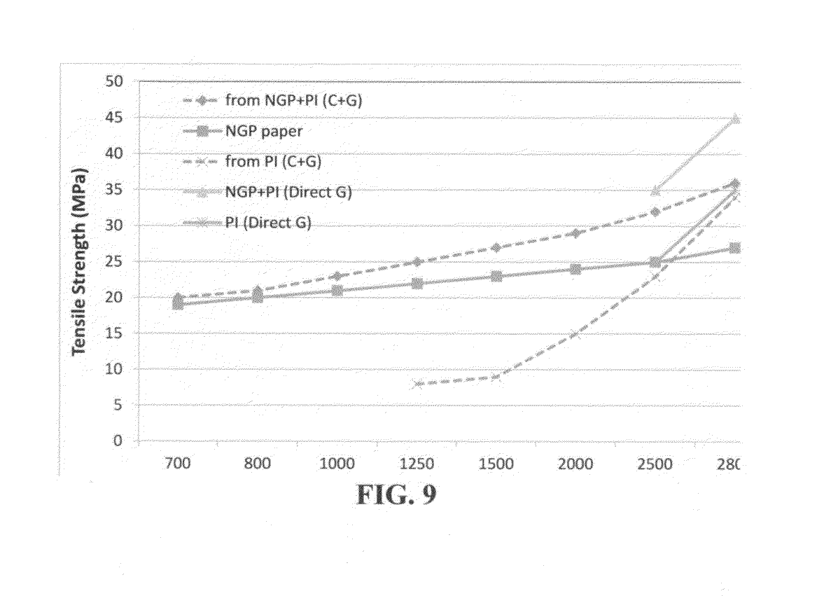

A universal testing machine was used to determine the tensile strength of these materials. The tensile strength values of NGP-PI derived films, PI-derived films, and NGP paper samples are plotted as a function of the graphitization temperature, FIG. 9. These data demonstrate that the tensile strength of the PI film are very low (<<10 MPa) unless the final heat treatment temperature exceeds 2,000° C. The strength of the NGP paper increases slightly (from 19 to 27 MPa) when the heat treatment temperature increases from 700 to 2,800° C. In contrast, the tensile strength of the NGP-reinforced PI derived films obtained via combined carbonization and graphitization increases significantly from 20 to 36 MPa over the same range of heat treatment temperatures. The corresponding films obtained via direct graphitization exhibit even higher strength values, some as high as 45 MPa.

In conclusion, we have successfully developed an absolutely new, novel, unexpected, and patently distinct process for producing highly conducting graphitic films. The process is fast and significantly less energy-intensive. The thin films produced with this process have the best combination of excellent electrical conductivity, thermal conductivity, and mechanical strength.

We claim:

1. An one-step process for producing a graphitic film, said process comprising directly feeding a precursor polymer film, without going through a carbonization step, to a graphitization zone preset at a graphitization temperature no less than 2,200° C. for a period of residence time sufficient for converting said precursor polymer film to a porous graphitic film having a density from 0.1 g/cm³ to 1.5 g/cm³ and retreating said porous graphitic film from said graphitization zone, wherein said precursor polymer film is selected from the group consisting of polyimide, polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, polyacrylonitrile, and combinations thereof.

2. The process of claim 1, further comprising a step of compressing said porous graphitic film to obtain a solid graphitic film having a physical density from 1.5 g/cm³ to 2.26 g/cm³.

3. The process of claim 1, wherein said graphitization temperature is no less than 2,500° C.

4. The process of claim 1, wherein said graphitization temperature is no less than 2,800° C.

5. The process of claim 1, wherein said process is a continuous process that includes continuously or intermittently feeding said precursor polymer film from one end of said graphitization zone and retreating said porous graphitic film from another end of said graphitization zone.

6. The process of claim 1, wherein said precursor polymer film is under a compression stress while residing in said graphitization zone.

7. The process of claim 1, wherein said precursor polymer film is supported on a first refractory material plate and covered by a second refractory material plate to exert a compressive stress to said precursor polymer film while residing in said graphitization zone.

8. The process of claim 7, wherein said first refractory material or second refractory material is selected from graphite, a refractory metal, or a carbide, oxide, boride, or nitride of a refractory element selected from tungsten, zirconium, tantalum, niobium, molybdenum, tantalum, or rhenium.

9. The process of claim 1, wherein said precursor polymer film has a thickness from 1 μm to 100 μm.

10. The process of claim 1, wherein said graphitization zone is at least 5 meters long.

11. The process of claim 1, wherein said graphitization zone is at a temperature no less than 2,750° C. and the residence time is from 3 hours to 12 hours.

12. The process of claim 1, wherein said precursor polymer film further contains multiple sheets of a graphene material dispersed therein, wherein said graphene material is selected from pristine graphene, oxidized graphene, reduced graphene oxide, fluorinated graphene, hydrogenated graphene, doped graphene, chemically functionalized graphene, or a combination thereof.

13. The process of claim 12, wherein the graphene material comprises a single-layer graphene sheet or a multi-layer graphene platelet with a thickness less than 10 nm.

14. The process of claim 12, wherein the graphene material comprise a multi-layer graphene platelet with a thickness less than 4 nm.

15. The process of claim 12, wherein the graphene material comprises a single-layer pristine graphene sheet or a multi-layer pristine graphene platelet with a thickness less than 10 nm and said pristine graphene sheet or pristine graphene platelet contains no oxygen and is produced from a process that does not involve oxidation.

16. The process of claim 12, wherein said carbon precursor material has a carbon yield of less than 50%.

17. The process of claim 1, wherein said precursor polymer film further contains expanded graphite flakes having a thickness greater than 100 nm.

18. An one-step process for producing a graphitic film, said process comprising directly feeding a precursor material film, without going through a carbonization step, to a graphitization zone preset at a graphitization temperature no less than 2,200° C. for a period of residence time sufficient for converting said precursor material film to a porous graphitic film having a density from 0.1 g/cm³ to 1.5 g/cm³ and retreating said porous graphitic film from said graphitization zone, wherein said precursor material film is selected from a petroleum pitch, coal tar pitch, meso-phase pitch, petroleum heavy oil, naphthalene, or organic material or polymer having a char yield from 5% to 40% and wherein said precursor material film has an amount, from 1% to 99% by weight, of graphene material sheets or expanded graphite flakes dispersed therein.

19. The process of claim 18, wherein said graphene material is selected from pristine graphene, oxidized graphene, reduced graphene oxide, fluorinated graphene, hydrogenated graphene, doped graphene, chemically functionalized graphene, or a combination thereof.

20. The process of claim 1, wherein said graphitization temperature is less than 2,500° C. and said graphitic film has an inter-graphene spacing less than 0.337 nm, a thermal conductivity of at least 1,200 W/mK, an electrical conductivity no less than 8,000 S/cm, a physical density greater than 1.9 g/cm3, and/or a tensile strength greater than 35 MPa.

21. The process of claim 1, wherein said graphitization temperature is higher than 2,500° C. and said graphitic film has an inter-graphene spacing less than 0.336 nm, a thermal conductivity of at least 1,300 W/mK, an electrical conductivity no less than 10,000 S/cm, a physical density greater than 2.0 g/cm3, and/or a tensile strength greater than 40 MPa.

22. The process of claim 1, wherein the graphitic film exhibits an inter-graphene spacing less than 0.337 nm and a mosaic spread value less than 1.0.

23. The process of claim 1, wherein the graphitic film exhibits a degree of graphitization no less than 60% and/or a mosaic spread value less than 0.7.

24. The process of claim 1, wherein the graphitic film exhibits a degree of graphitization no less than 90% and/or a mosaic spread value less than 0.4.

25. A graphitic film produced by the process as defined in claim 1.

26. An electronic device containing a graphitic film of claim 25 as a heat-dissipating element therein.
